(19) United States
(12) Patent Application Publication
(10) Pub. No.: US 2017/0051619 A1
(43) Pub. Date: Feb. 23, 2017

(54) CMC NOZZLES WITH SPLIT ENDWALLS FOR GAS TURBINE ENGINES

(71) Applicant: General Electric Company, Schenectady, NY (US)

(72) Inventor: Michael Ray TUERTSCHER, Fairfield, OH (US)

(21) Appl. No.: 14/828,580

(22) Filed: Aug. 18, 2015

(51) Int. Cl. F01D 9/04

(52) U.S. Cl. CPC F01D 9/047; F01D 9/041; F05D 2220/36; F05D 2240/128; F05D 2240/124; F05D 2300/6033; F05D 2300/10; F05D 2300/43

(57) ABSTRACT

Devices and methods are disclosed for making ceramic matrix composite (CMC) nozzles that limit thermal stresses from expansion and contraction, maintain tolerance on critical engineering dimensions, and reduces parasitic leakage associated with split line gaps in the CMC components. Cantilevered and herringbone patterns are formed by the split line gaps in the endwalls of the nozzles.

### FIELD OF THE INVENTION

The present subject matter relates generally to nozzles of gas turbine engines, and more particularly to devices and methods for making nozzles with split line gaps configured to reduce thermal stresses in the ceramic matrix composite (CMC) components and reduce parasitic leakage associated with the split line gaps.

### BACKGROUND OF THE INVENTION

A gas turbine engine generally includes, in serial flow order, a compressor section, a combustion section, a turbine section and an exhaust section. In operation, air enters an inlet of the compressor section where one or more axial compressors progressively compress the air until it reaches the combustion section. Fuel is mixed with the compressed air and burned within the combustion section to provide combustion gases that route from the combustion section through a hot gas path defined within the turbine section, and then exhausted from the turbine section via the exhaust section.

In particular configurations, the turbine section includes, in serial flow order, a high pressure (HP) turbine and a low pressure (LP) turbine. The HP turbine and the LP turbine each include various rotatable turbine components such as turbine rotor blades, rotor disks and retainers, and various stationary turbine components such as stator vanes or nozzles, turbine shrouds and engine frames. The rotatable and the stationary turbine components at least partially define the hot gas path through the turbine section. As the combustion gases flow through the hot gas path, thermal energy is transferred from the combustion gases to the rotatable turbine components and the stationary turbine components.

Nozzles utilized in gas turbine engines, and in particular HP turbine nozzles, are often arranged as an array of airfoil-shaped vanes extending between annular inner and outer endwalls which define the primary flowpath through the nozzles. Nozzles having integral inner and outer endwalls experience thermal stress concentration due to the closed structure of the nozzle assembly. The thermal stress and leakage of the components of neighboring nozzles arranged in an annular array is of particular concern for optimal gas turbine engine performance. Expansion and contraction of nozzle materials affects dimensions between features of neighboring nozzles, and in particular the airfoils. It is generally desirable that these engineering dimensions remain within desired predetermined tolerances for optimal gas turbine engine performance when the nozzles experience many cycles of thermal stress. If some of these dimensions are smaller than a predetermined optimal range, the gas turbine engine compressor can stall. If larger than the predetermined optimal range, the efficiency of the gas turbine engine can be lowered.

Accordingly, improved devices and methods for making CMC nozzles is desired. In particular, methods and devices for making nozzles that limit thermal stresses from expansion and contraction, maintain tolerance on critical engineering dimensions, and reduces parasitic leakage associated with split line gaps in the CMC components would be advantageous.

### BRIEF DESCRIPTION OF THE INVENTION

Aspects and advantages of the invention will be set forth in part in the following description, or may be obvious from the description, or may be learned through practice of the invention.

A cantilevered device is generally provided that limits both thermal stresses in the CMC components and leakage associated with split line gaps, along with methods for making such nozzles.

In accordance with one embodiment, the cantilevered nozzle includes at least two airfoils configured in a cantilevered pattern, each airfoil having an exterior surface defining a pressure side and a suction side extending between a leading edge and a trailing edge. An outer endwall is disposed radially outward of each airfoil, the outer endwall defining a leading edge face, a trailing edge face, and a radially outwardly-facing end surface. An inner endwall is disposed radially inward of each airfoil, the inner endwall defining a leading edge face, a trailing edge face, and a radially inwardly-facing end surface. Only one of the outer endwall and the inner endwall is segmented and the other endwall is integral. At least one split line gap is disposed on the segmented endwall adjacent to an endwall side surface. The at least one split line gap is positioned in a generally axial direction between each airfoil and extends between the leading edge face and trailing edge face of the segmented endwall.

In accordance with another embodiment, the cantilevered nozzle includes at least two airfoils configured in a herringbone pattern, each airfoil having an exterior surface defining a pressure side and a suction side extending between a leading edge and a trailing edge. An outer endwall is disposed radially outward of each airfoil, the outer endwall comprising a leading edge face, a trailing edge face, and a radially outwardly-facing end surface. An inner endwall is disposed radially inward of each airfoil, the inner endwall comprising a leading edge face, a trailing edge face, and a radially inwardly-facing end surface. At least two split line gaps are disposed alternately on the outer endwall and the inner endwall adjacent to an endwall side surface. The at least two split line gaps are positioned in a generally axial direction between the airfoils and extending between the leading edge face and trailing edge face of the outer endwall or the inner endwall.

In accordance with another embodiment, a device and method of making a nozzle assembly is disclosed. The nozzle assembly includes at least two airfoils, each airfoil having an exterior surface defining a pressure side and a suction side extending between a leading edge and a trailing edge. An outer endwall is disposed radially outward of each airfoil, the outer endwall comprising a leading edge face, a trailing edge face, and a radially outwardly-facing end surface. An inner endwall is disposed radially inward of each airfoil, the inner endwall comprising a leading edge face, a trailing edge face, and a radially inwardly-facing end surface. At least one split line gap is disposed adjacent a side surface on a segmented endwall selected from at least one of the group consisting of the outer endwall and the inner endwall. At least one split line gap is positioned in a generally axial direction between each airfoil and extends between the leading edge face and trailing edge face of said segmented endwall. A nozzle support structure includes a strut extending through each airfoil, the outer endwall of the nozzle and the inner endwall of the nozzle. An outer hanger is disposed radially outward of each airfoil, the outer hanger comprising a radially inwardly-facing end surface adjacent said outer endwall outwardly-facing end surface. An inner hanger is disposed radially inward of each airfoil, the inner hanger comprising a radially outwardly-facing end surface adjacent said inner endwall inwardly-facing end surface.

In some embodiments, the strut of the first nozzle assembly is joined to at least one of the inner hanger or the outer hanger of the first nozzle assembly and the strut of the second nozzle assembly is joined to at least one of the inner hanger or the outer hanger of the second nozzle assembly. In other embodiments, the strut of the first nozzle assembly is connected to at least one of the inner hanger or the outer hanger of the first nozzle assembly and the strut of the second nozzle assembly is connected to at least one of the inner hanger or the outer hanger of the second nozzle assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of a gas turbine engine in accordance with one embodiment of the present disclosure;

FIG. 2 is an enlarged circumferential cross sectional side view of a high pressure turbine portion of a gas turbine engine in accordance with one embodiment of the present disclosure;

FIG. 3 is a perspective view of an assembled nozzle assembly in accordance with one embodiment of the present disclosure;

FIG. 4 is a perspective view of a fully segmented nozzle assembly with joined neighboring nozzles, without split line gaps of the present disclosure;

FIG. 5 is a perspective view of a three airfoil segment of neighboring nozzles illustrating the outer endwall split line gaps between adjacent nozzles in accordance with the cantilevered embodiment of the present disclosure;

FIG. 6 is a perspective view of joined neighboring nozzle array assembly in accordance with the cantilevered embodiment of the present disclosure;

FIG. 7 is a perspective view of airfoils of neighboring nozzles illustrating the alternating outer and inner endwall split line gaps between adjacent nozzles in accordance with the herringbone embodiment of the present disclosure;

FIG. 8 is a perspective view of joined neighboring nozzle array assembly in accordance with the herringbone embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “rear” used in conjunction with “axial” or “axially” refers to a direction toward the engine nozzle, or a component being relatively closer to the engine nozzle as compared to another component. The terms “radial” or “radially” refer to a dimension extending between a center longitudinal axis of the engine and an outer engine circumference.

Gas turbine nozzles having integral inner and outer endwalls experience thermal stress concentration due to the closed structure of the nozzle assembly. Splitting a single endwall, inner or outer, forms a cantilevered nozzle structure with split line gaps that allows the integral (non-split) endwall to drive the thermal response of the component without fighting stresses imposed by the opposite (split) endwall. Alternatively, splitting the inner and outer endwalls, to form a herringbone nozzle structure, with split line gaps that allows the integral (non-split) portion of the endwall to drive the thermal response of the component without fighting stresses imposed by the opposite (split) portion of the endwall. Additionally, these embodiments provide larger nozzle segments to be joined thereby reducing the number of joints, split line cuts and gaps. Balancing leakage from split line cuts as well as thermal stresses is a critical design optimization in turbine component design. The present disclosure increases nozzle design space and provides optimized leakage and stress designs. Partially combining components through integral endwalls provides leakage benefit over a fully segmented component that manifests as a reduction in parasitic flows in the turbine design.

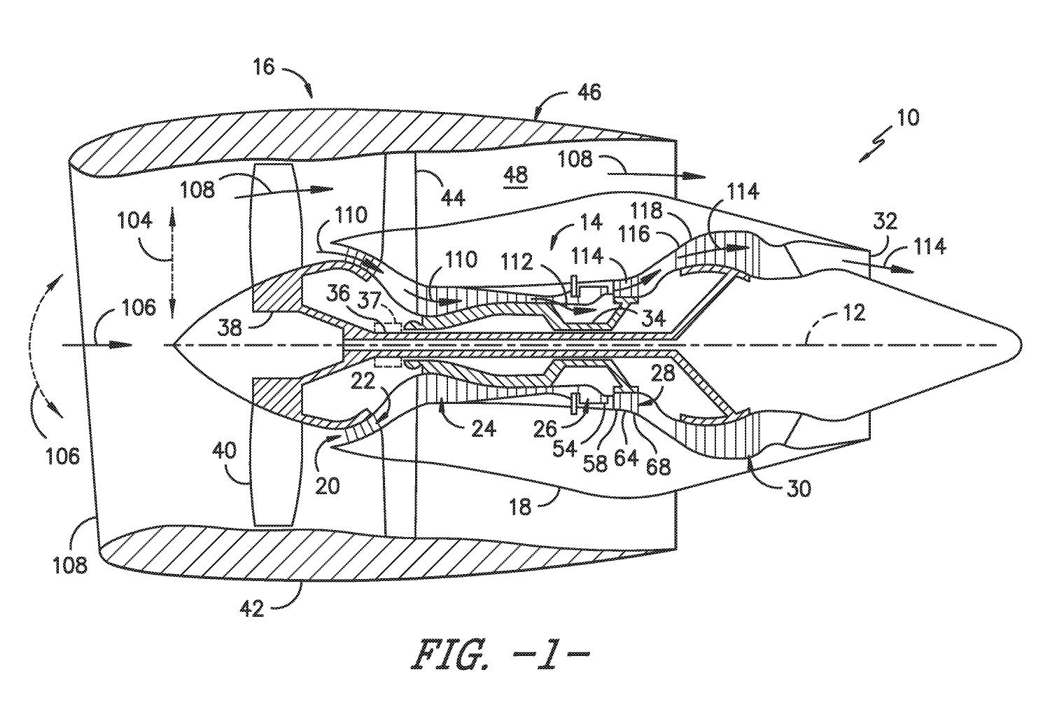

Referring now to the drawings, FIG. 1 is a schematic cross-sectional view of an exemplary high-bypass turbofan type engine 10 herein referred to as “turbofan 10” as may incorporate various embodiments of the present disclosure. As shown in FIG. 1, the turbofan 10 has a longitudinal or axial centerline axis 12 that extends therethrough for reference purposes. In general, the turbofan 10 may include a core turbine or gas turbine engine 14 disposed downstream from a fan section 16.

The gas turbine engine 14 may generally include a substantially tubular outer casing 18 that defines an annular inlet 20. The outer casing 18 may be formed from multiple casings. The outer casing 18 encases, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30, and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The (LP) spool 36 may also be connected to a fan spool or shaft 38 of the fan section 16. In particular embodiments, the (LP) spool 36 may be connected directly to the fan spool 38 such as in a direct-drive configuration. In alternative configurations, the (LP) spool 36 may be connected to the fan spool 38 via a speed reduction device 37 such as a reduction gear gearbox in an indirect-drive or geared-drive configuration. Such speed reduction devices may be included between any suitable shafts/spools within engine 10 as desired or required.

As shown in FIG. 1, the fan section 16 includes a plurality of fan nozzles 40 that are coupled to and that extend radially outwardly from the fan spool 38. An annular fan casing or nacelle 42 circumferentially surrounds the fan section 16 and/or at least a portion of the gas turbine engine 14. It should be appreciated by those of ordinary skill in the art that the nacelle 42 may be configured to be supported relative to the gas turbine engine 14 by a plurality of circumferentially-spaced outlet guide vanes 44. Moreover, a downstream section 46 of the nacelle 42 (downstream of the guide vanes 44) may extend over an outer portion of the gas turbine engine 14 so as to define a bypass airflow passage 48 therebetween.

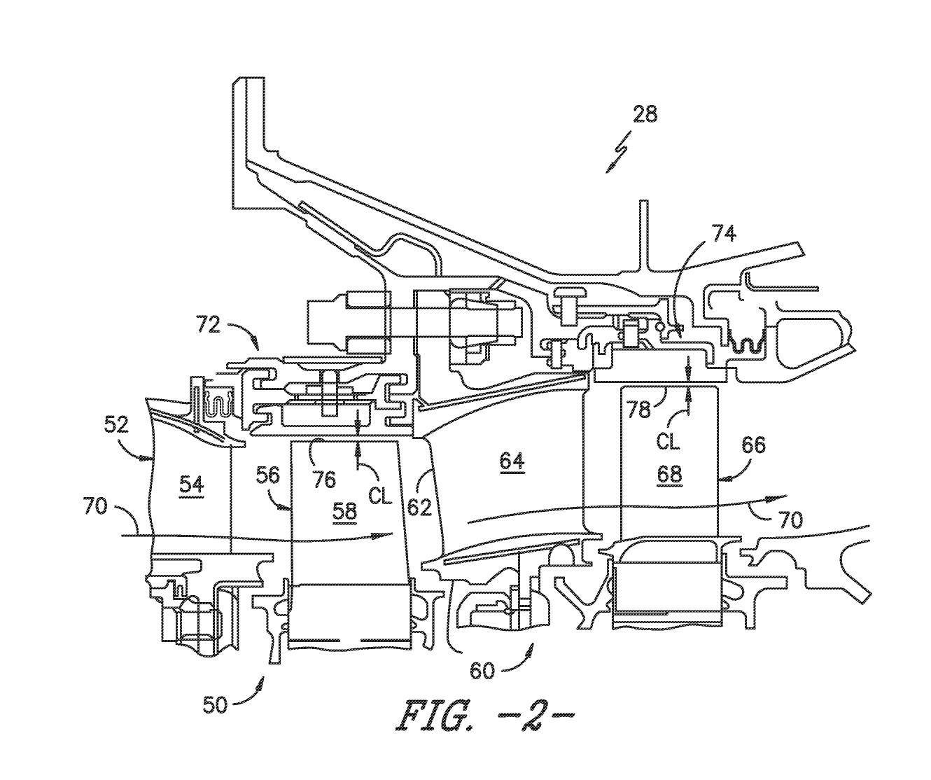

FIG. 2 provides an enlarged cross sectioned view of the HP turbine 28 portion of the gas turbine engine 14 as shown in FIG. 1, as may incorporate various embodiments of the present invention. As shown in FIG. 2, the HP turbine 28 includes, in serial flow relationship, a first stage 50 which includes an annular array 52 of stator vane nozzles 54 (only one shown) axially spaced from an annular array 56 of turbine rotor nozzles 58 (only one shown). The HP turbine 28 further includes a second stage 60 which includes an annular array 62 of stator vane nozzles 64 (only one shown) axially spaced from an annular array 66 of turbine rotor nozzles 68 (only one shown). The turbine rotor nozzles 58, 68 extend radially outwardly from and are coupled to the HP spool 34 (FIG. 1). As shown in FIG. 2, the stator vane nozzles 54, 64 and the turbine rotor nozzles 58, 68 at least partially define a hot gas path 70 for routing combustion gases from the combustion section 26 (FIG. 1) through the HP turbine 28.

As further shown in FIG. 2, the HP turbine may include one or more shroud assemblies, each of which forms an annular ring about an annular array of rotor nozzles. For example, a shroud assembly 72 may form an annular ring around the annular array 56 of rotor nozzles 58 of the first stage 50, and a shroud assembly 74 may form an annular ring around the annular array 66 of turbine rotor nozzles 68 of the second stage 60. In general, shrouds of the shroud assemblies 72, 74 are radially spaced from nozzle tips 76, 78 of each of the rotor nozzles 68. A radial or clearance gap CL is defined between the nozzle tips 76, 78 and the shrouds. The shrouds and shroud assemblies generally reduce leakage from the hot gas path 70.

It should be noted that shrouds and shroud assemblies may additionally be utilized in a similar manner in the low pressure compressor 22, high pressure compressor 24, and/or low pressure turbine 30. Accordingly, shrouds and shrouds assemblies as disclosed herein are not limited to use in HP turbines, and rather may be utilized in any suitable section of a gas turbine engine.

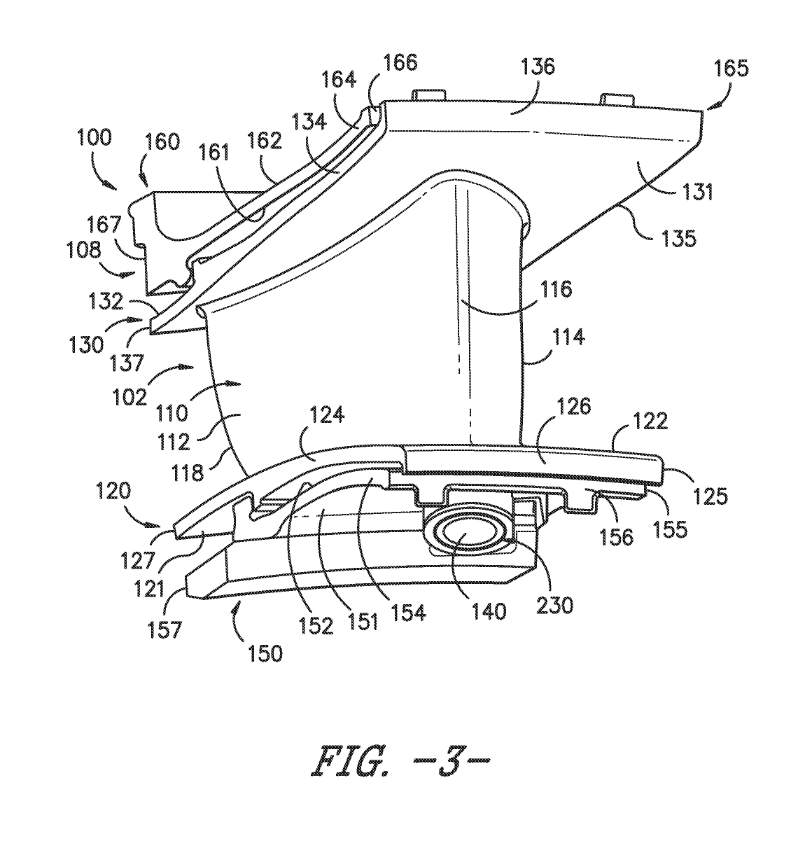

The position and condition of stator vane nozzles 54, 64 in an engine 10 is of particular concern, especially as affected by expansion and contraction of the nozzles due to the thermal stress and leakage of the nozzle assembly as it experiences numerous hot gas operation cycles. Accordingly, and referring now to FIG. 3 through 8, the present disclosure is further directed to devices and methods for assembling neighboring nozzles 102 of a gas turbine engine 10 to include endwall split line gaps. The neighboring nozzles 102 in accordance with the present disclosure are nozzles which are or will be next to one another in an annular array in engine 10. Nozzles 102 as disclosed herein may be utilized in place of stator vanes 54, stator vanes 64, or any other suitable stationary airfoil-based assemblies in an engine.

As shown for example in FIG. 3, a nozzle 102 in accordance with the present disclosure includes an airfoil 110, which has outer surfaces defining a pressure side 112, a suction side 114, a leading edge 116 and a trailing edge 118. The pressure side 112 and suction side 114 extend between the leading edge 116 and the trailing edge 118, as is generally understood. In typical embodiments, airfoil 110 is generally hollow, thus allowing cooling fluids to be flowed therethrough and structural reinforcement components to be disposed therein.

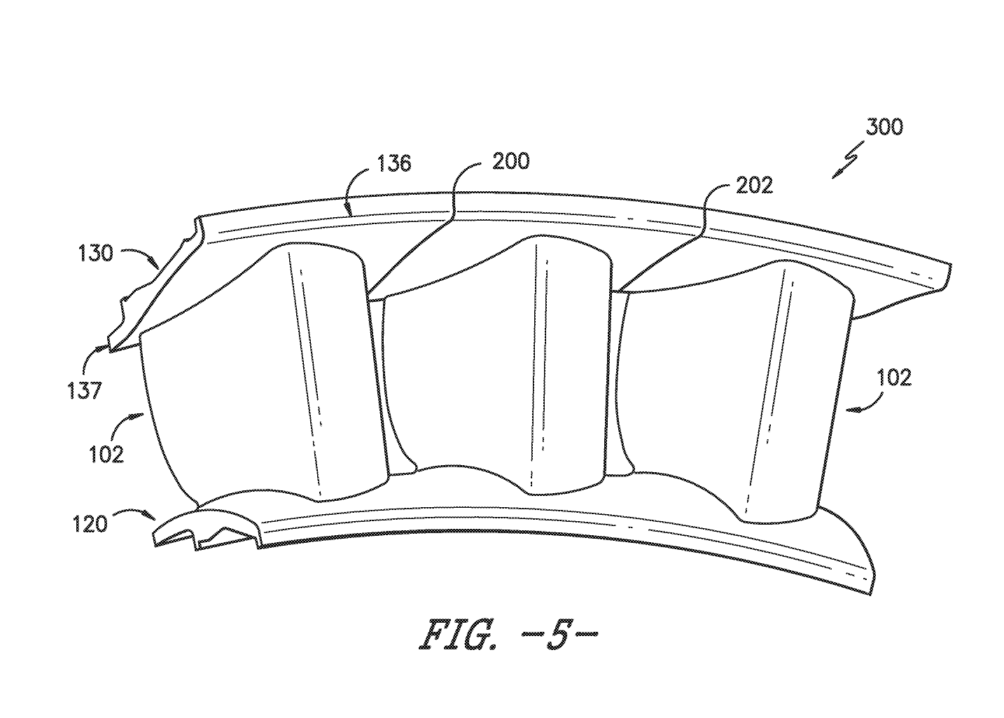

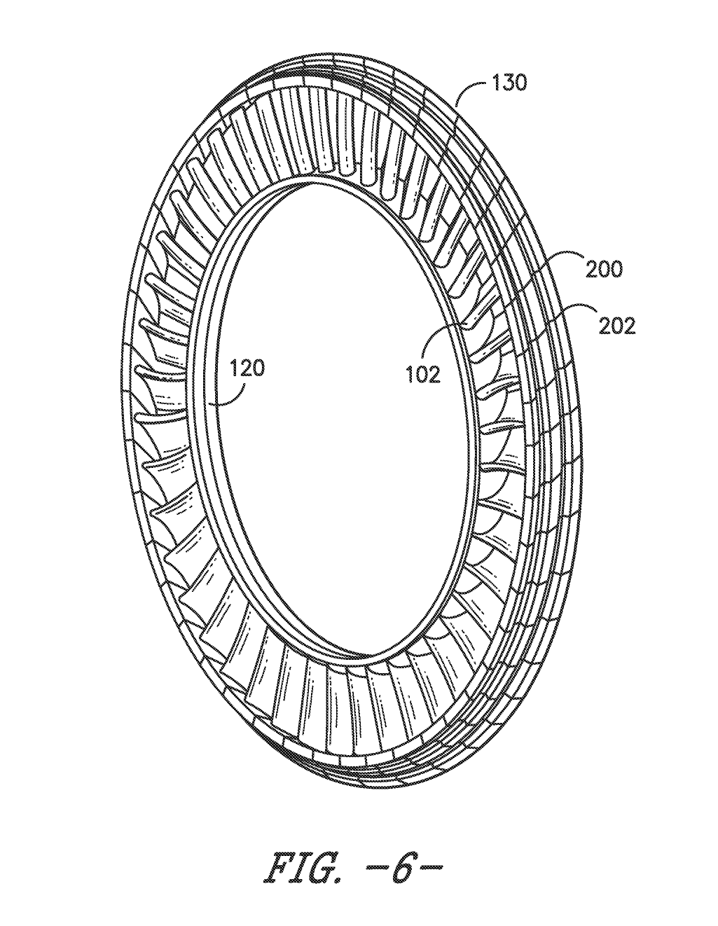

Nozzle 102 can further include an inner endwall 120 and an outer endwall 130, each of which is connected to the airfoil 110 at radially outer ends thereof generally along a radial direction 104. For the cantilever embodiment (FIGS. 5 and 6), adjacent nozzles 102 in an array of nozzles may be situated side by side along a circumferential direction 106, as shown, and positioned or cut such that the inner endwall 120 is integral, or contiguous, and neighboring side surfaces of the segmented outer endwall 130 contain split line gaps and are not in contact thereby cantilevering each nozzle from its inner endwall. Similarly, the nozzles can cantilever from the outer endwall 130 with the split line gaps positioned on the inner endwall 120.

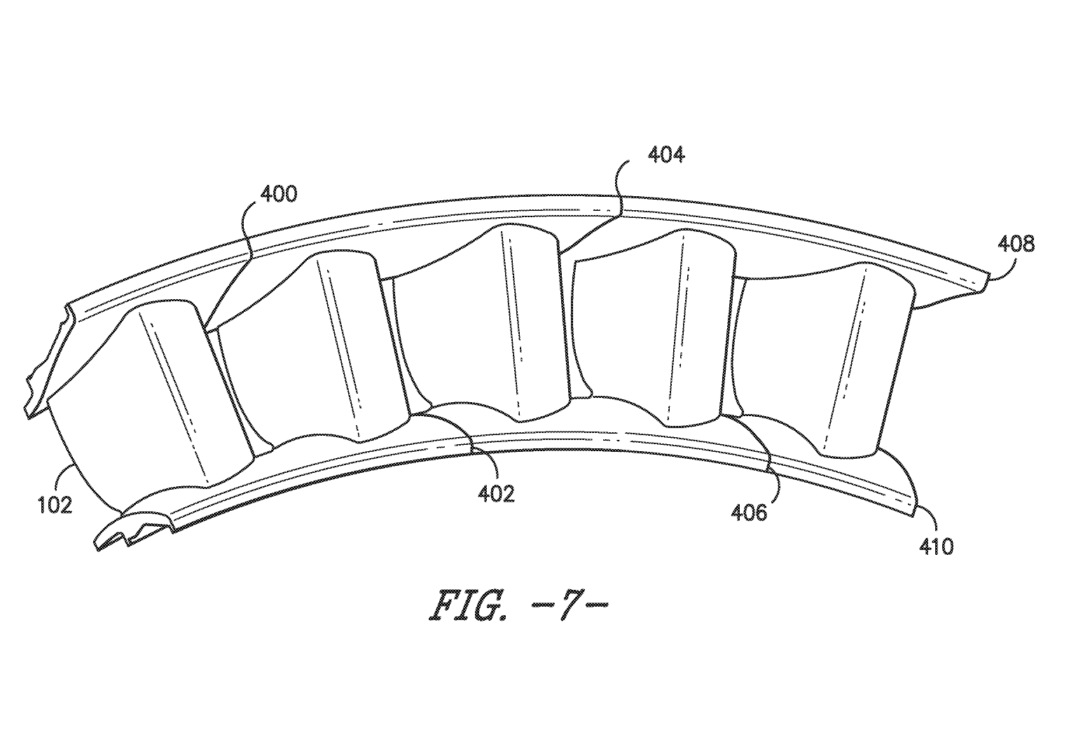

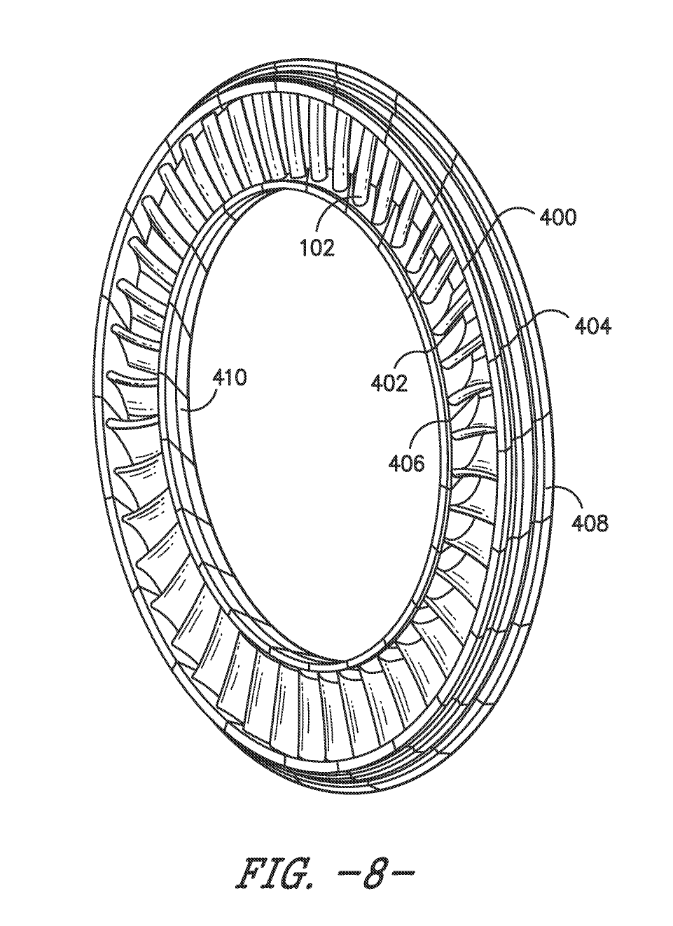

For the herringbone embodiment (FIGS. 7 and 8), adjacent nozzles 102 in an array of nozzles may be situated side by side along a circumferential direction 106, as shown, and positioned or cut such that every other neighboring nozzle of the inner endwall 120 contains a split line gap disposed at the nozzle side surface and are not in contact. Additionally, every other neighboring nozzle of the outer endwall 130 contains a split line gap disposed at the nozzle side surface and are not in contact, thereby forming a herringbone interconnecting pattern for the nozzle assembly. Inner endwall 120 may be disposed radially inward of the airfoil 110, while outer endwall 130 may be disposed radially outward of the airfoil 110. Inner endwall 120 may include, for example, a radially inwardly-facing end surface 121 and a radially outwardly-facing end surface 122 which are spaced apart radially from each other. Inner endwall 120 may further include various side surfaces, including a pressure side slash face 124, suction side slash face 125, leading edge face 126 and trailing edge face 127. Similarly, outer endwall 130 may include, for example, a radially inwardly-facing end surface 131 and a radially outwardly-facing end surface 132 which are spaced apart radially from each other. Outer endwall 130 may further include various side surfaces, including a pressure side slash face 134, suction side slash face 135, leading edge face 136 and trailing edge face 137.

In exemplary embodiments, the airfoil 110, inner endwall 120 and outer endwall 130 may be formed from ceramic matrix composite (“CMC”) materials. Alternatively, however, other suitable materials, such as suitable plastics, composites, metals, etc., may be utilized.

Nozzles 102 may be subjected to various loads during operation of the engine 10, including loads along an axial direction (as defined along the centerline 12). Further, differences in the materials utilized to form a nozzle 102 and associated support structure 108 (i.e. CMC and metal, respectively, in exemplary embodiments) may cause undesirable relative movements of the nozzle 102 and/or support structure 108 during engine operation, in particular along the radial direction 104. It is generally desirable to improve the load transmission between the associated nozzle 102 and support structure 108 and reduce the risk of damage to the component of the nozzle 102 that interface with the support structure 108 due to such loading and relative movement. The split line gaps arranged in a cantilevered or herringbone pattern as described in the present disclosure provide space for relative movement within design dimensional tolerances thereby reducing thermal stress on the nozzle assembly components.

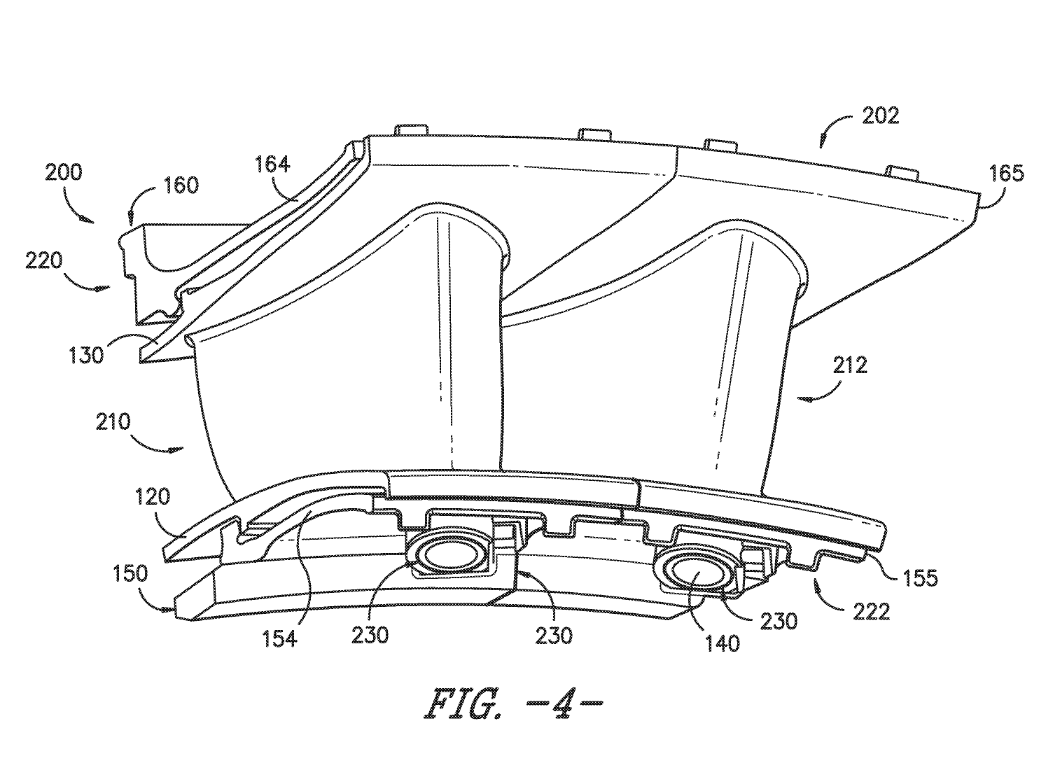

As seen in FIGS. 3 and 4, neighboring nozzles 102 are referred to respectively as a first nozzle 210 and a second nozzle 212. Neighboring nozzle assemblies 100 are referred to respectively as a first nozzle assembly 200 and a second nozzle assembly 202. Neighboring nozzles support structures 108 are referred to respectively as a first nozzle support structure 220 and a second nozzle support structure 222. First nozzle assembly 200 includes first nozzle 210 and first nozzle support structure 220, and second nozzle assembly 202 includes second nozzle 212 and second nozzle support structure 222. It should be understood that first and second nozzle assemblies 200, 202, nozzles 210, 212, and nozzle support structures 220, 222 may be any two neighboring nozzle assemblies 100, nozzles 102, and nozzle support structures 108, respectively, within or to be utilized within an engine 10.

In FIG. 3, a nozzle 102 in accordance with the present disclosure includes an airfoil 110, which has outer surfaces defining a pressure side 112, a suction side 114, a leading edge 116 and a trailing edge 118. The pressure side 112 and suction side 114 extend between the leading edge 116 and the trailing edge 118, as is generally understood. In typical embodiments, airfoil 110 is generally hollow, thus allowing cooling fluids to be flowed therethrough and structural reinforcement components to be disposed therein.

As further illustrated in FIG. 3, nozzle 102 may be a component of a nozzle assembly 100, which may additionally include a nozzle support structure 108. Each support structure 108 may be coupled to a nozzle 102 to support the nozzle 102 in engine 10. Further support structure 108 may transmit loads from the nozzle 102 to various other components within the engine 10.

Support structure 108 may include, for example, a strut 140. Strut 140 may generally extend through the airfoil 110, such as generally radially through the interior of the airfoil 110. Strut 140 may further extend through the inner endwall 120 and the outer endwall 130, such as through bore holes (not labeled) therein. In general, strut 208 may carry loads between the radial ends of the nozzle 102 to other components of the support structure 108. The loads may be transferred through these components to other components of the engine 10, such as the engine casing, etc.

For example, support structure 108 may include an inner hanger 150 and an outer hanger 160, each of which is connected to strut 140 at radially outer ends thereof generally along radial direction 104. Adjacent support structures 108 in an array of support structures 108 may be situated side by side along circumferential direction 106, as shown, with neighboring surfaces of the inner hangers 150 in contact and neighboring surfaces of the outer hangers 150. Inner hanger 150 may be disposed radially inward of the strut 140, while outer hanger 160 may be disposed radially outward of the strut 140. Further, inner hanger 150 may be positioned generally radially inward of the airfoil 110 and inner endwall 120. Outer hanger 160 may be positioned generally radially outward of the airfoil 110 and outer endwall 130. Inner hanger 150 may include, for example, a radially inwardly-facing end surface 151 and a radially outwardly-facing end surface 152 which are spaced apart radially from each other. Inner hanger 150 may further include various side surfaces, including a pressure side slash face 154, suction side slash face 155, leading edge face 156 and trailing edge face 157. Similarly, outer hanger 160 may include, for example, a radially inwardly-facing end surface 161 and a radially outwardly-facing end surface 162 which are spaced apart radially from each other. Outer hanger 160 may further include various side surfaces, including a pressure side slash face 164, suction side slash face 165, leading edge face 166 and trailing edge face 167.

In exemplary embodiments, the strut 140, inner hanger 150 and outer hanger 160 are formed from metals. Alternatively, however, other suitable materials, such as suitable plastics, composites, etc., may be utilized.

Accordingly, and referring now to FIG. 5, a three-airfoil nozzle segment 300 cantilevered from the inner endwall 120 in accordance with the present disclosure may further include one or more endwall split line gaps 200, 202 which are used to control nozzle material expansion and contraction loads between the associated nozzle 102 and support structure as well as between neighboring nozzles 102. Each split line gap 200, 202 of a nozzle 102 is saw cut through the outer endwall or dimensionally formed on each nozzle segment. The split line gaps extend generally axially through the endwall from the leading edge face 136 to the trailing edge face 137. The inner endwall 120 is integral, or contiguous, with no split line gaps. Alternatively, the nozzles 102 can be cantilevered from the outer endwall 130 with the split line gaps 200, 202 positioned on the inner endwall 120.

FIG. 6 is a perspective view of joined neighboring nozzle 102 array assembly in accordance with the cantilevered embodiment of the present disclosure and FIG. 5. The embodiment shown is cantilevered from the integral or contiguous inner endwall 120 with split line gaps 200, 202 positioned full perimeter on the outer endwall 130.

FIG. 7 is a perspective view of five airfoils 102 with two segments of neighboring nozzles illustrating the alternating outer endwall 408 and inner endwall 410 split line gaps 400, 402, 404, 406 between adjacent nozzle segments in accordance with the herringbone embodiment of the present disclosure. This embodiment may require additional connection joints at the interface between some of the airfoils and the endwalls. For example, one airfoil (of the two airfoil segment) may have no endwall, either outer or inner depending on the relative position of the segment in the array, until the neighboring segment is joined to provide the missing endwall. The connection may nest the airfoil inside of an endwall cavity that matches the airfoil profile.

FIG. 8 is a perspective view of joined neighboring nozzle 102 array assembly in accordance with the herringbone embodiment of the present disclosure and FIG. 7. This embodiment shows the alternating split line gaps 400, 402, 404, and 406 positioned between every other airfoil around the full perimeter on the outer endwall 130 and inner endwall 120.

Methods in accordance with the present disclosure may include, for example, assembling a first nozzle assembly 200 and a second nozzle assembly 202. FIGS. 3 and 4 illustrate one embodiment of a nozzle assembly, which may be a first nozzle assembly 200 or a second nozzle assembly 202, which has been assembled in accordance with the present disclosure. In the embodiment of FIG. 4, the steps of assembling the first and second nozzle assemblies 200, 202 are performed before other steps of the present method, including a joining step as discussed herein.

An assembled first or second nozzle assembly 200, 202 includes a nozzle 210, 212 and a nozzle support structure 220, 222. The strut 140 of the nozzle support structure 220, 222 generally extends through the nozzle 210, 212, such as through the airfoil 110, inner endwall 120 and outer endwall 130 thereof. In exemplary embodiments, the step of assembling a first nozzle assembly 200 and/or second nozzle assembly 202 includes, for example, the step of inserting the strut 140 of the first or second nozzle support structure 220, 222 through the first or second nozzle 210, 222, such as through the airfoil 210, inner endwall 120 and outer endwall 130 thereof. The step of assembling the first nozzle assembly 200 and/or second nozzle assembly 202 may further include, for example, the step of joining the strut 140 of the first or second nozzle support structure 220, 222 to one or both of the inner hanger 150 or outer hanger 160 of the first or second nozzle support structure 220, 222. In some embodiments, the strut 140 may be integral with one of the inner hanger 150 or outer hanger 160, and thus not require joining to this hanger. In other embodiments, the strut 140 may require joining to both hangers 150, 160. For example, in the embodiment of FIG. 3, the strut 140 is integral with the outer hanger 160 and joined to inner hanger 150.

Joining of components in accordance with the present disclosure may form a joint 230 between the components. In exemplary embodiments, joining is accomplished by brazing the components, such as the strut 140 and inner and/or outer hangers 150, 160, together. Alternatively, joining may be accomplished by welding or another suitable joining technique. Joining techniques in accordance with the present disclosure generally utilized a melted and then solidified filler material and/or melted and then solidified surfaces of the components to fix the subject components together. Connecting of components in accordance with the present disclosure may be accomplished via, for example, a suitable mechanical fastener or another suitable technique that generally results in a removable connection.

A method in accordance with the present disclosure may further include, for example, the step of joining the first nozzle support structure 210 and the second nozzle support structure 212 together. For example, the joining step may include joining the inner hangers 150 of the first nozzle support structure 210 and second nozzle support structure 222 together and joining the outer hangers 160 of the first nozzle support structure 210 and second nozzle support structure 212 together. In particular, and as shown for example in FIG. 4, the suction side slash face 155 of the inner hanger 150 of the first nozzle support structure 210 and the pressure side slash face 154 of the inner hanger 150 of the second nozzle support structure 212 may be joined together, and the suction side slash face 165 of the outer hanger 160 of the first nozzle support structure 210 and the pressure side slash face 164 of the outer hanger 160 of the second nozzle support structure 212 may be joined together. Connecting of components in accordance with the present disclosure may be accomplished via, for example, a suitable mechanical fastener or another suitable technique that generally results in a removable connection.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A nozzle for a gas turbine engine, the nozzle comprising:
at least two airfoils configured in a cantilevered pattern, each airfoil having an exterior surface defining a pressure side and a suction side extending between a leading edge and a trailing edge;
an outer endwall disposed radially outward of each airfoil, the outer endwall comprising a leading edge face, a trailing edge face, and a radially outwardly-facing end surface;
an inner endwall disposed radially inward of each airfoil, the inner endwall comprising a leading edge face, a trailing edge face, and a radially inwardly-facing end surface;
wherein one of said outer endwall and said inner endwall is a segmented endwall and the other is an integral endwall; and
at least one split line gap disposed on the segmented endwall adjacent to an endwall side surface, said at least one split line gap positioned in a generally axial direction between each airfoil and extending between the leading edge face and trailing edge face of said segmented endwall.

2. The nozzle of claim 1 wherein said at least two airfoils are configured in an annular array.

3. The nozzle of claim 2, wherein said nozzle is a stationary stator vane nozzle in a turbofan.

4. The nozzle of claim 3, further comprising:
at least one shroud assembly.

5. The nozzle of claim 4, wherein said shroud assembly forms an annular ring around said stationary stator vanes nozzles.

6. The nozzle of claim 1, wherein said at least two airfoils are generally hollow.

7. The nozzle of claim 1, wherein said inner endwall further comprises at least one side surface selected from the group consisting of pressure side slash face, suction side slash face.

8. The nozzle of claim 1 wherein said outer endwall further comprises at least one side surface selected from the group consisting of pressure side slash face, suction side slash face.

9. The nozzle of claim 1, wherein the at least two airfoils, outer endwall and inner endwall are formed from at least one material selected from the group consisting of composites, ceramic matrix composite, plastic and metal.

10. A nozzle for a gas turbine engine, the nozzle comprising:
at least two airfoils configured in a herringbone pattern, each airfoil having an exterior surface defining a pressure side and a suction side extending between a leading edge and a trailing edge;
an outer endwall disposed radially outward of each airfoil, the outer endwall comprising a leading edge face, a trailing edge face, and a radially outwardly-facing end surface;
an inner endwall disposed radially inward of each airfoil, the inner endwall comprising a leading edge face, a trailing edge face, and a radially inwardly-facing end surface; and
at least two split line gaps disposed alternately on the outer endwall and the inner endwall adjacent to an endwall side surface, said at least two split line gaps positioned in a generally axial direction between the airfoils and extending between the leading edge face and trailing edge face of said outer endwall or said inner endwall.

11. The nozzle of claim 10 wherein said at least two airfoils are configured in an annular array.

12. The nozzle of claim 11 wherein said nozzle is configured as stationary stator vane nozzles in a turbofan.

13. The nozzle of claim 12 further comprising at least one shroud assembly.

14. The nozzle of claim 13 wherein said shroud assembly forms an annular ring around said stationary stator vanes nozzles.

15. The nozzle of claim 10 wherein said at least two airfoils are generally hollow.

16. The nozzle of claim 10 wherein said inner endwall further comprises at least one side surface selected from the group consisting of pressure side slash face, suction side slash face.

17. The nozzle of claim 10 wherein said outer endwall further comprises at least one side surface selected from the group consisting of pressure side slash face, suction side slash face.

18. The nozzle of claim 10, wherein the at least two airfoils, outer endwall and inner endwall are formed from at least one material selected from the group consisting of composites, ceramic matrix composite, plastic and metal.

19. A nozzle assembly for a gas turbine engine, the nozzle assembly comprising:
at least two airfoils, each airfoil having an exterior surface defining a pressure side and a suction side extending between a leading edge and a trailing edge;
an outer endwall disposed radially outward of each airfoil, the outer endwall comprising a leading edge face, a trailing edge face, and a radially outwardly-facing end surface;
an inner endwall disposed radially inward of each airfoil, the inner endwall comprising a leading edge face, a trailing edge face, and a radially inwardly-facing end surface; and
at least one split line gap disposed adjacent an endwall side surface on a segmented endwall selected from at least one of the group consisting of the outer endwall and the inner endwall, said at least one split line gap positioned in a generally axial direction between each airfoil and extending between the leading edge face and trailing edge face of said segmented endwall, and
a nozzle support structure, the nozzle support structure comprising:
a strut extending through each airfoil, the outer endwall of the nozzle and the inner endwall of the nozzle;
an outer hanger disposed radially outward of each airfoil, the outer hanger comprising a radially inwardly-facing end surface adjacent said outer endwall outwardly-facing end surface; and
an inner hanger disposed radially inward of each airfoil, the inner hanger comprising a radially outwardly-facing end surface adjacent said inner endwall inwardly-facing end surface.

20. The nozzle assembly of claim 19, wherein the at least two airfoils, outer endwall, inner endwall, and nozzle support structure are formed from at least one material selected from the group consisting of composites, ceramic matrix composite, plastic and metal.
